(19) United States
(12) Patent Application Publication
(10) Pub. No.: US 2019/0357323 A1
(43) Pub. Date: Nov. 21, 2019

(54) MICROWAVE TRIM KIT ASSEMBLY

(71) Applicant: Furrion Property Holding Limited, Hong Kong (HK)

(72) Inventor: Steven N. Bell, Hong Kong (HK)

(21) Appl. No.: 15/985,329

(22) Filed: May 21, 2018

(51) Int. Cl. H05B 6/64; F24C 15/30

(52) U.S. Cl. CPC H05B 6/6429; F24C 15/30

(57) ABSTRACT

A microwave trim assembly is configured to be assembled from a kit of multiple pieces that can be coupled together without the use of independent fasteners such as screws or bolts. Pieces of the kit are assembled using clasps. The microwave trim assembly is also, or alternatively, configured to be coupled to a microwave without the use of independent fasteners such as screws or bolts, by using one or more mounting clips provided on the trim assembly.

### BACKGROUND

Microwave ovens (referred to herein as “microwaves”) can be installed in vehicles such as campers, recreational vehicles, and boats. When installing microwaves in microwave cabinets in vehicles, there may be a gap left between the edges of the microwave and the edge of the cabinet cavity within which the microwave is disposed. A trim assembly may be coupled to the microwave to cover the gap and/or add an aesthetically pleasing exterior trim to the microwave. Generally, trim assemblies are welded or screwed together from multiple pieces and must be fixed into place on the microwave using independent fasteners such as screws or bolts.

### SUMMARY

Embodiments of the subject matter disclosed herein include microwave trim assemblies that are configured to be assembled from a kit of multiple pieces that can be coupled together without the use of independent fasteners such as screws or bolts. Additionally or alternatively, embodiments include microwave trim assemblies that are configured to be coupled to microwaves without the use of independent fasteners such as screws or bolts.

In an Example 1, a trim kit for providing a trim assembly for a microwave includes: an upper trim piece having a first end and a second end; a lower trim piece configured to be arranged at least approximately parallel to the upper trim piece, the lower trim piece having a first end and a second end; a first side trim piece configured to extend between the first end of the upper trim piece and the first end of the lower trim piece, and having a first end and a second end; and a second side trim piece configured to extend between the second end of the upper trim piece and the second end of the lower trim piece, and having a first end and a second end, wherein the second side trim piece is configured to be arranged at least approximately parallel to the first side trim piece; wherein at least one of the first and second side trim pieces is configured to be coupled to at least one of the upper trim piece and the lower trim piece via at least one clasp; and wherein the upper trim piece, the lower trim piece, the first side trim piece, and the second side trim piece form a trim assembly.

In an Example 2, the trim kit of Example 1, the at least one clasp comprising a first clasp, wherein the first end of the first side trim piece comprises a first clasp portion, and the first end of the upper trim piece comprises a second clasp portion that is configured to couple with the first clasp portion to form a first clasp.

In an Example 3, the trim kit of Example 2, wherein the second end of the first side trim piece comprises a third clasp portion, and the first end of the lower trim piece comprises a fourth clasp portion that is configured to couple with the third clasp portion to form a second clasp.

In an Example 4, the trim kit of Example 3, wherein the first end of the second side trim piece comprises a fifth clasp portion, and the second end of the upper trim piece comprises a sixth clasp portion that is configured to couple with the fifth clasp portion to form a third clasp.

In an Example 5, the trim kit of Example 4, wherein the second end of the second side trim piece comprises a seventh clasp portion, and the second end of the lower trim piece comprises an eighth clasp portion that is configured to couple with the seventh clasp portion to form a fourth clasp.

In an Example 6, the trim kit of Example 1, wherein the microwave comprises a microwave configured to be installed in at least one of a recreational vehicle (RV), a camper, and a boat.

In an Example 7, the trim kit of Example 2, the first clasp portion comprising an insertion member, the second clasp portion comprising a receiving member, and wherein the insertion member is configured to be inserted into the receiving member.

In an Example 8, the trim kit of Example 1, wherein the first side trim piece includes a first mounting tab configured to engage a first mounting bracket extending from a first side of the microwave, and wherein the second side trim piece includes a second mounting tab configured to engage a second mounting bracket extending from the second side of the microwave.

In an Example 9, the trim kit of Example 8, wherein the trim assembly can be mounted to the microwave without the use of independent fasteners.

In an Example 10, A method includes: assembling a trim assembly using a trim kit, wherein assembling the trim assembly comprises: coupling a first end of a first side trim piece to a first end of an upper trim piece; coupling a second end of the first side trim piece to a first end of a lower trim piece; coupling a first end of a second side trim piece to a second end of the upper trim piece; and coupling a second end of the second trim piece to a second end of the lower trim piece; and coupling, without using screws, the trim assembly to the microwave.

In an Example 11, the method of Example 10, wherein assembling the trim assembly is performed without using screws.

In an Example 12, the method of Example 10, further comprising installing the microwave into a microwave cabinet prior to the step of coupling the trim assembly to the microwave.

In an Example 13, the method of Example 10, wherein the first side trim piece is coupled to the upper trim piece using a first clasp and wherein the first side trim piece is coupled to the lower trim piece using a second clasp, wherein the first end of the first side trim piece comprises a first clasp portion, and the first end of the upper trim piece comprises a second clasp portion that is configured to couple with the first clasp portion to form the first clasp.

In an Example 14, the method of Example 13, the first clasp portion comprising an insertion member, the second clasp portion comprising a receiving member, and wherein coupling the first side of the first side trim piece to the first side of the upper trim piece comprises inserting the insertion member into the receiving member.

In an Example 15, the method of Example 10, the first side trim piece comprising a first mounting tab configured to engage a first mounting bracket extending from a first side of the microwave, the second side trim piece comprising a second mounting tab configured to engage a second mounting bracket extending from the second side of the microwave, wherein coupling the trim assembly to the microwave comprises pushing the trim assembly onto the front of the microwave so that the first and second mounting tabs engage the first and second mounting brackets, respectively.

In an Example 16, a trim assembly is provided for a microwave, wherein the microwave comprises a microwave configured to be installed in at least one of a recreational vehicle (RV), a camper, and a boat, the trim assembly including: an upper trim piece having a first end and a second end; a lower trim piece configured to be arranged at least approximately parallel to the upper trim piece, the lower trim piece having a first end and a second end; a first side trim piece extending between the first end of the upper trim piece and the first end of the lower trim piece, and having a first end and a second end; and a second side trim piece extending between the second end of the upper trim piece and the second end of the lower trim piece, and having a first end and a second end, wherein the second side trim piece is arranged at least approximately parallel to the first side trim piece; wherein the first side trim piece includes a first mounting tab configured to engage a first mounting bracket extending from a first side of the microwave, and wherein the second side trim piece includes a second mounting tab configured to engage a second mounting bracket extending from the second side of the microwave; and wherein the trim assembly is configured to be mounted to the microwave without the use of screws.

In an Example 17, the trim assembly of Example 16, wherein at least one of the first and second side trim pieces is configured to be coupled to at least one of the upper trim piece and the lower trim piece via at least one clasp.

In an Example 18, the trim assembly of Example 17, the at least one clasp comprising a first clasp, wherein the first end of the first side trim piece comprises a first clasp portion, and the first end of the upper trim piece comprises a second clasp portion that is configured to couple with the first clasp portion to form a first clasp.

In an Example 19, the trim assembly of Example 18, the first clasp portion comprising an insertion member, the second clasp portion comprising a receiving member, and wherein the insertion member is configured to be inserted into the receiving member.

In an Example 20, the trim assembly of Example 16, the receiving member comprising an inner wall, at least a portion of the inner wall defining at least a portion of an aperture, and a first guide feature disposed on the inner wall, wherein the insertion member includes a second guide feature configured to engage the first guide feature when the insertion member is inserted into the receiving member.

While multiple embodiments are disclosed, still other embodiments of the presently disclosed subject matter will become apparent to those skilled in the art from the following detailed description, which shows and describes illustrative embodiments of the disclosed subject matter. Accordingly, the drawings and detailed description are to be regarded as illustrative in nature and not restrictive.

### BRIEF DESCRIPTION OF THE DRAWINGS

FIG. 1A is a front perspective view of an illustrative microwave having a trim assembly attached thereto, in accordance with embodiments of the subject matter disclosed herein.

FIG. 1B is a front perspective view of the illustrative microwave depicted in FIG. 1A, without the trim assembly, in accordance with embodiments of the subject matter disclosed herein.

FIG. 2A is a rear perspective view of an illustrative trim assembly 200 for use with a microwave, showing the trim assembly 200 assembled, in accordance with embodiments of the subject matter disclosed herein.

FIG. 2B is a rear perspective exploded view of the illustrative trim assembly 200, in accordance with embodiments of the subject matter described herein.

FIG. 3A is a front perspective view of an illustrative clasp, in an uncoupled state, in accordance with embodiments of the subject matter disclosed herein.

FIG. 3B is a front perspective view of the illustrative clasp, in a coupled state, in accordance with embodiments of the subject matter disclosed herein.

FIG. 3C is a lower perspective view of the second clasp portion of the clasp depicted in FIGS. 3A and 3B, in accordance with embodiments of the subject matter disclosed herein.

FIG. 3D is a front perspective view of the first clasp portion of the clasp depicted in FIGS. 3A and 3B, in accordance with embodiments of the subject matter disclosed herein.

FIG. 4A is a rear perspective view of a microwave having a trim assembly attached thereto, in accordance with embodiments of the subject matter disclosed herein.

FIG. 4B is a perspective view of the first side trim piece and the first mounting bracket depicted in FIG. 4A, in accordance with embodiments of the subject matter disclosed herein.

FIG. 4C is a top view of the first side trim piece and the first mounting bracket, in accordance with embodiments of the subject matter disclosed herein.

FIG. 5 is a flow diagram depicting an illustrative method of installing a microwave, in accordance with embodiments of the subject matter disclosed herein.

While the disclosed subject matter is amenable to various modifications and alternative forms, specific embodiments have been shown by way of example in the drawings and are described in detail below. The intention, however, is not to limit the subject matter disclosed herein to the particular embodiments described. On the contrary, the disclosure is intended to cover all modifications, equivalents, and alternatives falling within the scope of the subject matter disclosed herein, and as defined by the appended claims.

As used herein in association with values (e.g., terms of magnitude, measurement, and/or other degrees of qualitative and/or quantitative observations that are used herein with respect to characteristics (e.g., dimensions, measurements, attributes, components, etc.) and/or ranges thereof, of tangible things (e.g., products, inventory, etc.) and/or intangible things (e.g., data, electronic representations of currency, accounts, information, portions of things (e.g., percentages, fractions), calculations, data models, dynamic system models, algorithms, parameters, etc.), “about” and “approximately” may be used, interchangeably, to refer to a value, configuration, orientation, and/or other characteristic that is equal to (or the same as) the stated value, configuration, orientation, and/or other characteristic or equal to (or the same as) a value, configuration, orientation, and/or other characteristic that is reasonably close to the stated value, configuration, orientation, and/or other characteristic, but that may differ by a reasonably small amount such as will be understood, and readily ascertained, by individuals having ordinary skill in the relevant arts to be attributable to measurement error; differences in measurement and/or manufacturing equipment calibration; human error in reading and/or setting measurements; adjustments made to optimize performance and/or structural parameters in view of other measurements (e.g., measurements associated with other things); particular implementation scenarios; imprecise adjustment and/or manipulation of things, settings, and/or measurements by a person, a computing device, and/or a machine; system tolerances; control loops; machine-learning; foreseeable variations (e.g., statistically insignificant variations, chaotic variations, system and/or model instabilities, etc.); preferences; and/or the like.

The terms “up,” “upper,” and “upward,” and variations thereof, are used throughout this disclosure for the sole purpose of clarity of description and are only intended to refer to a relative direction (i.e., a certain direction that is to be distinguished from another direction), and are not meant to be interpreted to mean an absolute direction. Similarly, the terms “down,” “lower,” and “downward,” and variations thereof, are used throughout this disclosure for the sole purpose of clarity of description and are only intended to refer to a relative direction that is at least approximately opposite a direction referred to by one or more of the terms “up,” “upper,” and “upward,” and variations thereof.

Although the term “block” may be used herein to connote different elements illustratively employed, the term should not be interpreted as implying any requirement of, or particular order among or between, various blocks disclosed herein. Similarly, although illustrative methods may be represented by one or more drawings (e.g., flow diagrams, communication flows, etc.), the drawings should not be interpreted as implying any requirement of, or particular order among or between, various steps disclosed herein. However, certain embodiments may require certain steps and/or certain orders between certain steps, as may be explicitly described herein and/or as may be understood from the nature of the steps themselves (e.g., the performance of some steps may depend on the outcome of a previous step). Additionally, a “set,” “subset,” or “group” of items (e.g., inputs, algorithms, data values, etc.) may include one or more items, and, similarly, a subset or subgroup of items may include one or more items. A “plurality” means more than one.

### DETAILED DESCRIPTION

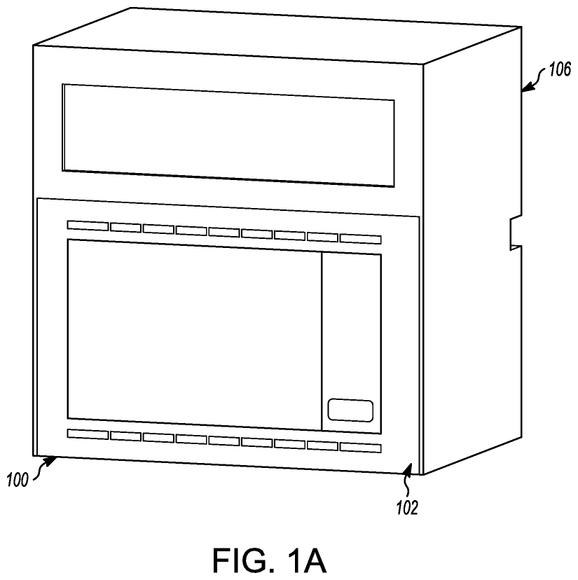

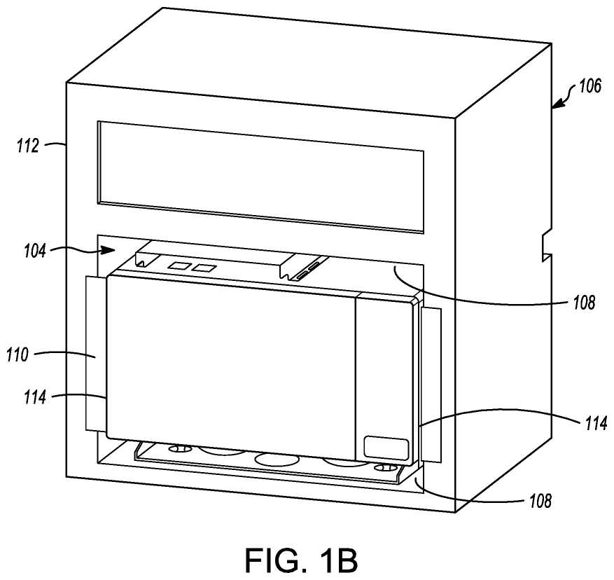

FIG. 1A is a front perspective view of an illustrative microwave 100 having a trim assembly 102 attached thereto, in accordance with embodiments of the subject matter disclosed herein. FIG. 1B is a front perspective view of the illustrative microwave 100 depicted in FIG. 1A, without the trim assembly 102, in accordance with embodiments of the subject matter disclosed herein. According to embodiments, the microwave 100 may be configured to be installed in at least one of a recreational vehicle (RV), a camper, and a boat. In embodiments, the microwave 100 may be configured to be installed in any number of additional, or alternative, locations such as, for example, in a tiny house, a cabin, a house, an office, a hotel room, and/or the like.

Embodiments of the trim assembly 102 described herein may be used for covering gaps around microwaves and/or improving an aesthetic appearance of an outside of a microwave. For example, as shown in FIG. 1B, the microwave 100 may be disposed within a cavity 104 defined in a microwave cabinet 106. The trim assembly 102 may be configured to cover a gap 108 between the microwave 100 and the edges of the cavity 104. Embodiments of the trim assembly 102 may be configured to be coupled to the microwave 100 without using independent fasteners such as screws or bolts. As shown, for example, the microwave 100 may include mounting brackets 110 extending from the sides of the microwave and configured to be secured to a front surface 112 (and/or an inside side surface, lower surface, upper surface, etc.) of the microwave cabinet 106. The trim assembly 102 may be configured to be coupled to the mounting brackets 110 without using independent fasteners such as screws or bolts. For example, one or more mounting clips (not shown) provided on the trim assembly 102 may be disposed within gaps 114 provided by the structure of the mounting brackets 110 and may be configured to engage one or more engagement features (not shown) provided on the mounting brackets 110.

The illustrative microwave 100 and trim assembly 102 shown in FIGS. 1A and 1B is not intended to suggest any limitation as to the scope of use or functionality of embodiments of the present disclosure. The illustrative microwave 100 and trim assembly 102 should not be interpreted as having any dependency or requirement related to any single component or combination of components illustrated therein. Additionally, various components depicted in FIGS. 1A and 1B may be, in embodiments, integrated with various ones of the other components depicted therein (and/or components not illustrated), all of which are considered to be within the ambit of the subject matter disclosed herein.

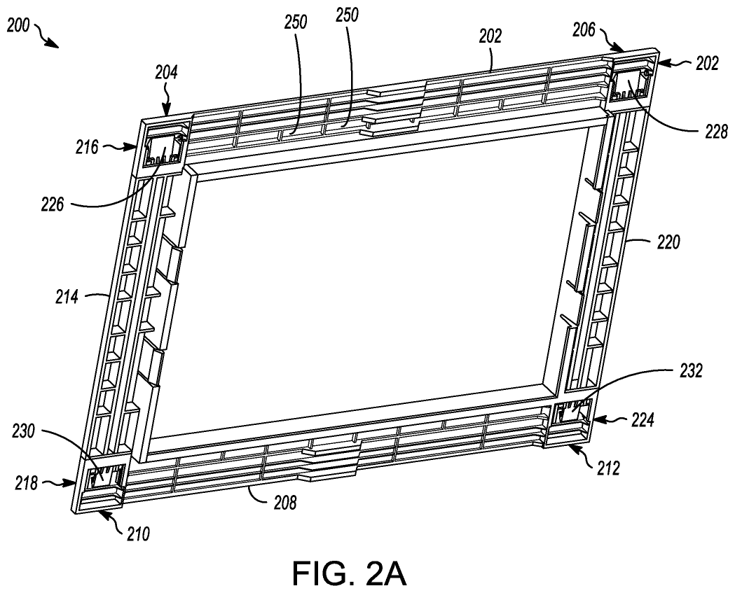

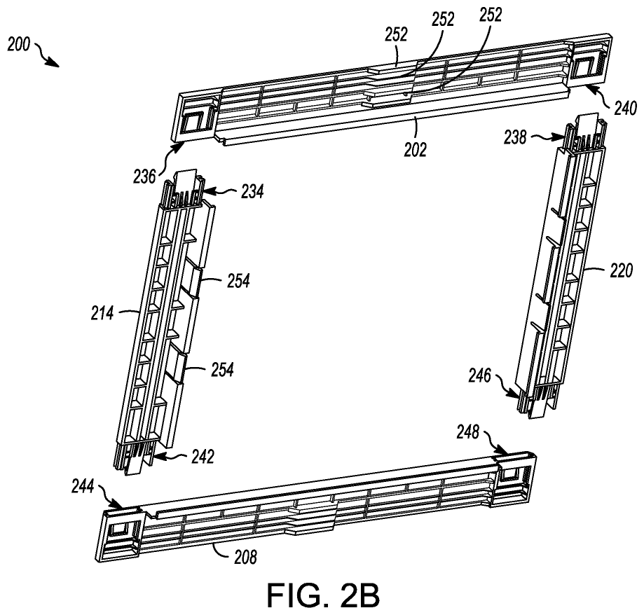

In addition to, or in lieu of, being configured to be mounted to a microwave without the use of independent fasteners, embodiments of the trim assembly described herein may be configured to be assembled from a trim kit having two or more parts and without using independent fasteners such as screws or bolts. FIG. 2A is a rear perspective view of an illustrative trim assembly 200 for use with a microwave, showing the trim assembly 200 assembled; and FIG. 2B is a rear perspective exploded view of the illustrative trim assembly 200, in accordance with embodiments of the subject matter described herein. According to embodiments, the trim assembly 200 may be, be similar to, include, or be included in the trim assembly 102 depicted in FIG. 1A.

As shown in FIGS. 2A and 2B, the trim assembly 200 includes an upper trim piece 202 having a first end 204 and a second end 206, a lower trim piece 208 configured to be arranged at least approximately parallel to the upper trim piece 202. The lower trim piece 208 includes a first end 210 and a second end 212. A first side trim piece 214 is configured to extend between the first end 204 of the upper trim piece 202 and the first end 210 of the lower trim piece 208, and includes a first end 216 and a second end 218. A second side trim piece 220 is configured to extend between the second end 206 of the upper trim piece 202 and the second end 212 of the lower trim piece 208, and includes a first end 222 and a second end 224. In embodiments, the second side trim piece 220 is configured to be arranged at least approximately parallel to the first side trim piece 214. The upper trim piece 202, the lower trim piece 208, the first side trim piece 214, and the second side trim piece 220 may all be components of a microwave trim kit. The trim kit may be, for example, sold separately from, or together with, a microwave to which it is configured to be coupled.

According to embodiments, at least one of the first and second side trim pieces 214 and 220 may be configured to be coupled to at least one of the upper trim piece 202 and the lower trim piece 208 via at least one clasp. According to embodiments, the trim kit may include the four separate trim pieces described above, in which all of the couplings between trim pieces are accomplished via one or more clasps. In other embodiments, two or more of the trim pieces may already be coupled (e.g., permanently or temporarily). As shown in FIG. 2B, the at least one clasp may include a first clasp 226 configured to couple the first end 216 of the first side trim piece 214 to the first end 204 of the upper trim piece 202. A second clasp 228 may be configured to couple the first end 222 of the second side trim piece 220 to the second end 206 of the upper trim piece 202. A third clasp 230 may be configured to couple the second end 218 of the first side trim piece 214 to the first end 210 of the lower trim piece 208. A fourth clasp 232 may be configured to couple the second end 224 of the second side trim piece 220 to the second end 212 of the lower trim piece 208. According to embodiments, any one of more of the connections described above may be accomplished using any number of clasps.

As shown, for example, the first end 216 of the first side trim piece 214 may be or include a first clasp portion 234, and the first end 204 of the upper trim piece 202 may be or include a second clasp portion 236 that is configured to couple with the first clasp portion 234 to form the first clasp 226. Similarly, as shown, the first end 222 of the second side trim piece 220 may be or include a third clasp portion 238, and the second end 206 of the upper trim piece 202 may be or include a fourth clasp portion 240 that is configured to couple with the third clasp portion 238 to form the second clasp 228. The second end 218 of the first side trim piece 214 may be or include a fifth clasp portion 242, and the first end 210 of the lower trim piece 202 may be or include a sixth clasp portion 244 that is configured to couple with the fifth clasp portion 242 to form the third clasp 228. Additionally, the second end 224 of the second side trim piece 220 may be or include a seventh clasp portion 246, and the second end 212 of the lower trim piece 202 may be or include an eighth clasp portion 248 that is configured to couple with the seventh clasp portion 246 to form the fourth clasp 232. According to embodiments, the clasps have any number of different configurations, and may include any number of different types of buttons, levers, and/or the like.

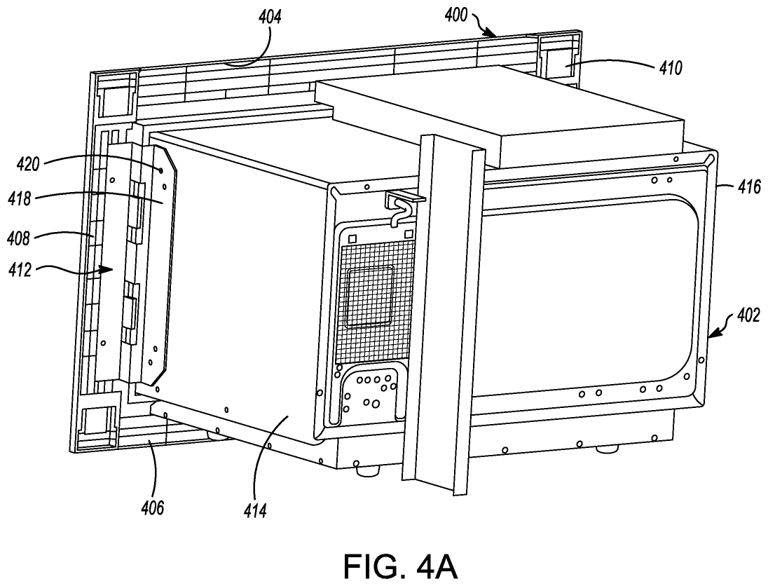

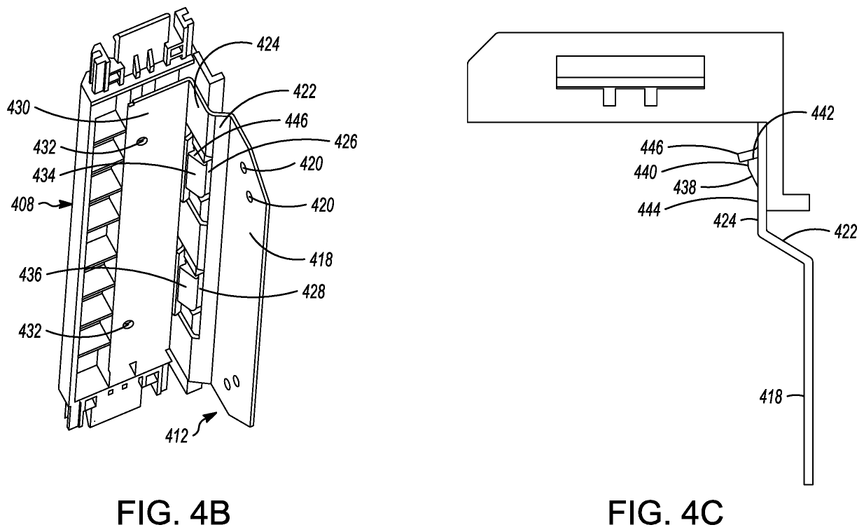

The illustrative trim assembly 200 shown in FIGS. 2A and 2B is not intended to suggest any limitation as to the scope of use or functionality of embodiments of the present disclosure. The illustrative trim assembly 200 should not be interpreted as having any dependency or requirement related to any single component or combination of components illustrated therein. For example, as shown one or more of the upper trim piece 202, the lower trim piece 208, the first side trim piece 214 and the second side trim piece 220 may include vents 250 disposed therein. Additionally, or alternatively, any one or more the trim pieces 202, 208, 214, and 220 may include any number of different aesthetic (decorative) features, mounting support features 252 (e.g., for providing support between a middle portion of a trim piece and a surface disposed behind it such as a microwave cabinet), and/or the like. For example, as described below in relation to FIGS. 4A-4C, the side trim pieces 214 and 220 may include mounting tabs 254 configured to facilitate coupling the trim assembly 200 to a microwave. Additionally, various components depicted in FIGS. 2A and 2B may be, in embodiments, integrated with various ones of the other components depicted therein (and/or components not illustrated), all of which are considered to be within the ambit of the subject matter disclosed herein.

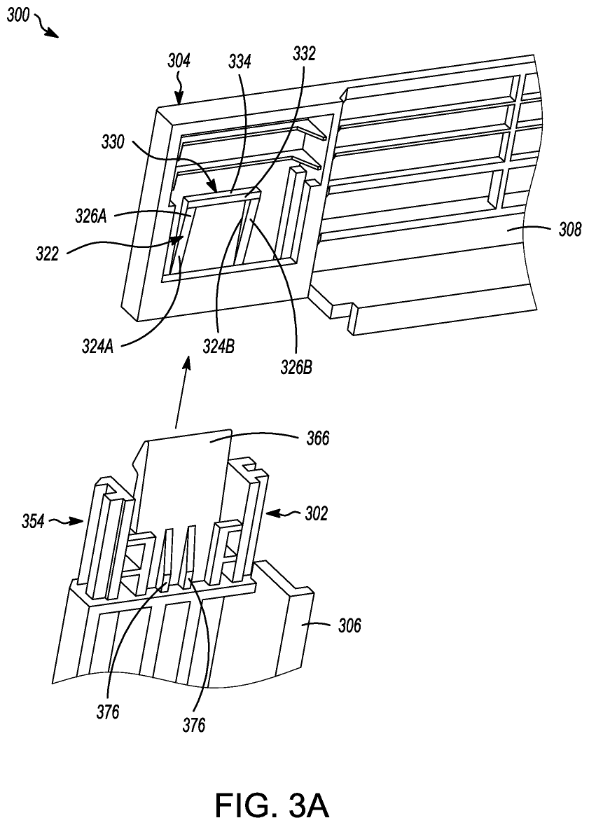

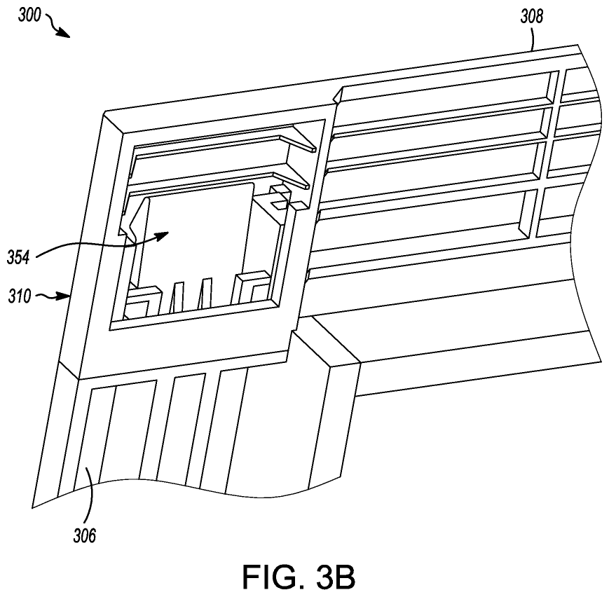

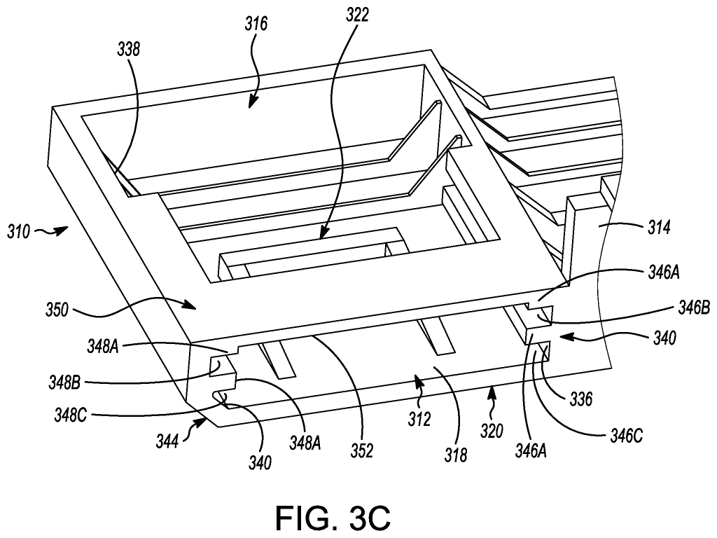

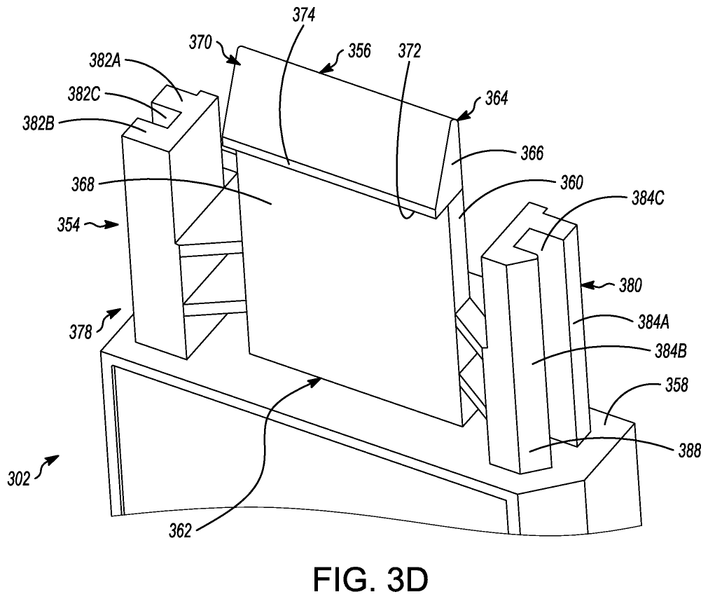

FIGS. 3A-3D depict an illustrative clasp 300, in accordance with embodiments of the subject matter disclosed herein. FIG. 3A is a front perspective view of an illustrative clasp 300, in an uncoupled state, while FIG. 3B is a front perspective view of the illustrative clasp 300, in a coupled state, in accordance with embodiments of the subject matter disclosed herein. According to embodiments, the clasp 300 may be, be similar to, include, or be included in the any one or more of the clasps 226, 228, 230, and 232 depicted in FIGS. 2A and 2B. As shown, for example, the clasp 300 includes a first clasp portion 302 and a second clasp portion 304, where the first clasp portion 302 is configured to be coupled to the second clasp portion 304 to couple a first trim piece 306 to a second trim piece 308.

FIG. 3C is a lower perspective view of the second clasp portion 304, and FIG. 3D is a front perspective view of the first clasp portion 302, in accordance with embodiments of the subject matter disclosed herein. As shown in FIGS. 3A and 3C, the second clasp portion 304 includes a receiving member 310. The receiving member 310 includes an aperture 312 defined in a first surface 314 of the clasp portion 304. In embodiments, the first surface 314 of the clasp portion 304 may be a surface extending along an edge of the corresponding trim piece 308. In embodiments, for example, the first surface 314 may be a surface extending along a lower edge of an upper trim piece (e.g., the upper trim piece 202 depicted in FIGS. 2A and 2B), an upper edge of a lower trim piece (e.g., the lower trim piece 208 depicted in FIGS. 2A and 2B), and/or an inner edge of a side trim piece (e.g., the first side trim piece 214 and/or the second side trim piece 220 depicted in FIGS. 2A and 2B). The shape of the aperture 312 may be designed in any number of different ways. For example, as shown, the shape is designed as an irregular geometric shape.

The illustrated receiving member 310 includes a cavity 316 extending from the aperture 312, defined and at least partially enclosed by an inner surface 318 of a first wall 320. The receiving member 310 includes an inclined ramp 322, that includes two ramp walls 324A and 324B extending away from the inner surface 318, the distance away from the inner surface 318 of an outer surface 326A and 326B of each wall 324A and 324B, respectively, increasing in a direction extending inward from the aperture 312. The ramp includes an engagement wall 330 extending between the two ramp walls 324A and 324B, and having an outer surface 332 and an engagement surface 334 oriented at least approximately perpendicularly to the outer surface 332. In embodiments, the ramp 322 may include an inclining outer surface extending between the two ramp walls 324A and 324B, and corresponding to outer surfaces 326A and 326B. In embodiments, the inclining ramp 322 may be a single part.

As shown in FIG. 3C, the receiving member 310 may further include a pair of opposed inner side surfaces 336 and 338 and an inner angled surface 340. According to embodiments, at least one of the inner side surfaces 336 and 338 and the inner angled surface 340 may include a guide feature. In the illustrated embodiments, for example, the inner side surfaces 336 and 338 each include a guide feature 342 and 344, respectively. As shown, each guide feature 342 and 344 includes at least one protruding wall 346A and 348A (two on each side are shown in FIG. 3C), respectively, extending inward from the respective inner surface 336 and 338, respectively, thereby defining channels 346B and 346C corresponding to the protruding walls 346A and channels 348B and 348C corresponding to the protruding walls 348A. A second wall 350 may include an inner surface 352 that is opposed to at least a portion of the inner surface 318 of the first wall 320, as shown in FIGS. 3A and 3C. According to embodiments, the receiving member 310 may include any number of additional features, features with different designs, and/or the like.

As shown in FIGS. 3B and 3D, the first clasp portion 302 includes an insertion member 354 configured to be inserted into the receiving member 310 to couple the first clasp portion 302 to the second clasp portion 304. As shown, the insertion member 354 includes a clip portion 356 extending away from an outer surface 358. The outer surface 358 may be configured to engage the first surface 314 of the second clasp portion 304 upon full insertion of the insertion member 354 into the receiving member 310. The clip portion 356 includes a tongue 360 extending from a first end 362 away from the outer surface 358 to a second end 364 and having an outer surface 366 and an opposite inner surface 368.

An inclined ramp 370 is disposed at the second end 364 of the tongue 360, with the inclination in the direction from the second end 364 toward the first end 362. A locking wall 372 extends from a shoulder 374 toward the inner surface 368 and may be, in embodiments, at least approximately perpendicular to the inner surface 368. The inclined ramp 370 is configured to engage the inclined ramp 322 of the receiving member 310 as the insertion member 354 is pushed into the receiving member 310, causing the tongue 360 to be bent away from the inner surface of the receiving member 310 until the shoulder 374 has moved past the end of the inclined ramp 322 of the receiving member 310. Once the shoulder 374 has moved past the end of the inclined ramp 322 of the receiving member, the tongue 360, moves back toward its original position, moving in a direction toward the inner surface 318 until the inner surface 368 of the tongue engages the outer surface 332 of the ramp 322. In this coupled position, the locking surface 372 of the inclined ramp 370 of the tongue 360 engages the engagement surface 334 of the ramp 322, preventing the insertion member 354 from moving out of the receiving member 310.

The insertion member 354 may include any number of stabilizing and/or guiding features. For example, one or more return features 376 disposed on the outer surface of the tongue 360 may be configured to engage the inner surface 352 of the second wall 350 of the receiving member 310, thereby biasing the tongue 360 toward the inner surface 318 of the receiving member 310 to facilitate pushing the tongue 360 toward the inner surface 318 of the receiving member 310 into the coupled position.

As is also shown in FIGS. 3B and 3D, the insertion member 354 may include a pair of guide features 378 and 380, each corresponding to one of the guide features 342 and 344, respectively, of the receiving member 310. The illustrated guide feature 378 includes a pair of protruding walls 382A and 382B, defining a channel 382C between them; and the illustrated guide feature 380 includes a pair of protruding walls 384A and 384B, defining a channel 384C between them. In this manner, when the insertion member 354 is inserted into the receiving member 310, the protruding walls 382A and 382B are configured to be disposed within channels 346B and 346C, respectively; and the protruding walls 384A and 384B are configured to be disposed within channels 348B and 348C, respectively, thereby facilitating guiding the insertion member 354 into the coupling position within the receiving member 310 and, in embodiments, preventing the insertion member 354 from twisting within the receiving member 310, thereby strengthening the connection.

According to embodiments, any one or more aspects of the insertion member 354 may also be configured to match the size and/or shape of the aperture 312 of the receiving member to facilitate stable insertion of the insertion member 310. In embodiments, the insertion member may be configured so that it can only be positioned within the receiving member 310 in one particular orientation, or any one of a number of particular orientations. For example, as shown in FIG. 3D, the wall 384B of the guide feature 380 includes an angled outer surface 388 that is configured to correspond to, and slideably engage, the angled inner surface 340 of the receiving member 310. In this manner, the insertion member 354 can only be inserted into the receiving member 310 in one orientation, thereby ensuring proper coupling of the appropriate trim pieces together in the appropriate arrangement.

The illustrative clasp 300 shown in FIGS. 3A-3D is not intended to suggest any limitation as to the scope of use or functionality of embodiments of the present disclosure. The illustrative clasp 300 should not be interpreted as having any dependency or requirement related to any single component or combination of components illustrated therein. Additionally, various components depicted in FIGS. 3A-3D may be, in embodiments, integrated with various ones of the other components depicted therein (and/or components not illustrated), all of which are considered to be within the ambit of the subject matter disclosed herein.

FIGS. 4A-4C depict an illustrative process of coupling a trim assembly 400 to a microwave 402 without using independent fasteners such as, for example, screws or bolts. FIG. 4A is a rear perspective view of the microwave 402 having a trim assembly 400 attached thereto, in accordance with embodiments of the subject matter disclosed herein. According to embodiments, the trim assembly 402 may be, be similar to, include, or be included in the trim assembly 102 depicted in FIG. 1A, the trim assembly 200 depicted in FIGS. 2A and 2B; and the microwave 400 may be, be similar to, include, or be included in the microwave 100 depicted in FIGS. 1A and 1B. As shown in FIG. 4A, the trim assembly 402 includes an upper trim piece 404, a lower trim piece 406, a first side trim piece 408, and a second side trim piece 410. As shown, the microwave 400 includes a first mounting bracket 412 extending from a first side 414 of the microwave 400 and a second mounting bracket (not shown) extending from a second side 416 of the microwave 400. According to embodiments, the mounting brackets 412, (not shown) may be, be similar to, include, or be included in the mounting brackets 110 depicted in FIG. 1B. Additionally, although the second mounting bracket is not depicted in the drawings, it should be understood that the description herein of the first mounting bracket 412 may, in embodiments, also apply to the second mounting bracket (though the orientations may be mirror-images of those described herein).

As shown in FIGS. 4A, for example, the mounting bracket 412 may include a first wall 418 configured to be disposed adjacent to the first side 414 of the microwave 402. The first wall 418 may include apertures 420 through which independent fasteners such as, for example, screws, may be passed to facilitate coupling the first wall 418 to the first side 414 of the microwave 402. FIG. 4B is a perspective view of the first side trim piece 408 and the first mounting bracket 412, and FIG. 4C is a top view of the first side trim piece 408 and the first mounting bracket 412, in accordance with embodiments of the subject matter disclosed herein. As shown, the mounting bracket 412 may include a second, angled wall 422 extending from a front edge of the first wall 418 at least partially toward the front of the microwave 402; and a third wall 424 extending from a front edge of the second wall 422. In embodiments, the third wall 424 may be at least approximately parallel to the first wall 418 and may include slots 426 and 428 defined therein. A fourth wall 430 may extend away from the front edge of the third wall 424, at least approximately perpendicular to the third wall 424. The fourth wall 430 may be configured to be disposed adjacent an outer surface of a microwave cabinet (as shown, e.g., in FIG. 1B) and may include apertures 432 for receiving independent fasteners such as screws to secure the mounting bracket 412, and thus the microwave 402, to the cabinet.

As shown in FIGS. 4A-4C, the first side trim piece 408 may include a number of mounting tabs 434 and 436, and within each of the slots 426 and 428 may be positioned a mounting tab 434 and 436, respectively. In embodiments the first side trim piece 408 may include any number of mounting tabs (1, 2, 3, etc.) and each of the mounting tabs may be similar in structure and/or function. As an example, a first mounting tab 434 may include a tongue (not shown) having an inclined ramp 438 disposed at an inner end of the tongue. The inclined ramp 438 inclines in the direction toward the front of the microwave 402 when the trim assembly 400 is mounted on the microwave 402, and includes a shoulder 440 from which an engagement surface 442 extends back toward an outer surface 444 of the third wall 424. The engagement surface 442 is configured to engage an engagement feature 446 extending from the third wall 424 and extending at least partially outwardly away from the microwave, thereby preventing the trim assembly from being dislodged. In embodiments, the engagement feature 446 may include a flap of metal bent outwardly from the third wall 424.

The illustrative trim assembly 400 and microwave 402 shown in FIGS. 4A-4C is not intended to suggest any limitation as to the scope of use or functionality of embodiments of the present disclosure. The illustrative trim assembly 400 and microwave 402 should not be interpreted as having any dependency or requirement related to any single component or combination of components illustrated therein. Additionally, various components depicted in FIGS. 4A-4C may be, in embodiments, integrated with various ones of the other components depicted therein (and/or components not illustrated), all of which are considered to be within the ambit of the subject matter disclosed herein.

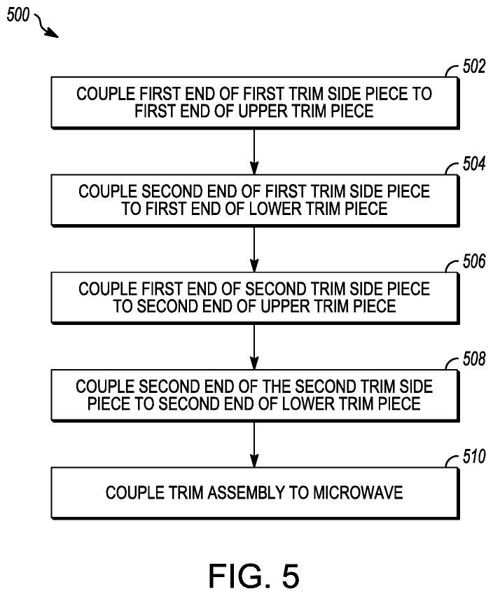

Embodiments of trim assemblies and trim kits for forming trim assemblies have been discussed above. Embodiments of the subject matter disclosed herein also include methods for assembling, using, and otherwise providing the trim assemblies (e.g., the trim assembly 102 depicted in FIG. 1A, the trim assembly 200 depicted in FIGS. 2A and 2B, and/or the trim assembly 400 depicted in FIG. 4A) for use with microwaves (e.g., the microwave 100 depicted in FIGS. 1A and 1B and/or the microwave 402 depicted in FIG. 4A). FIG. 5 is a flow diagram depicting an illustrative method 500 of installing a microwave, in accordance with embodiments of the subject matter disclosed herein. As shown, the method 500 may include coupling (block 502) a first end of a first side trim piece to a first end of an upper trim piece; coupling (block 504) a second end of the first side trim piece to a first end of a lower trim piece; coupling (block 506) a first end of a second side trim piece to a second end of the upper trim piece; and coupling (block 508) a second end of the second trim piece to a second end of the lower trim piece. In embodiments, steps 502, 504, 506, and 508 are configured to form a trim assembly. Assembly of the trim assembly may include assembling the assembly without using independent fasteners such as, for example, screws. As shown in FIG. 5, embodiments of the illustrative method further include coupling (block 510), without using screws, the trim assembly to the microwave. This may be done, for example, by pushing the trim assembly onto the front of the microwave so that the mounting tabs engage the first and second mounting brackets, respectively. Additionally, in embodiments, the method 500 includes installing the microwave into a microwave cabinet prior to the step of coupling the trim assembly to the microwave.

Various modifications and additions can be made to the exemplary embodiments discussed without departing from the scope of the present disclosure. For example, while the embodiments described above refer to particular features, the scope of this disclosure also includes embodiments having different combinations of features and embodiments that do not include all of the described features. Accordingly, the scope of the present disclosure is intended to embrace all such alternatives, modifications, and variations as fall within the scope of the claims, together with all equivalents thereof.

I claim:

1. A trim kit for providing a trim assembly for a microwave, comprising:
an upper trim piece having a first end and a second end;
a lower trim piece configured to be arranged at least approximately parallel to the upper trim piece, the lower trim piece having a first end and a second end;
a first side trim piece configured to extend between the first end of the upper trim piece and the first end of the lower trim piece, and having a first end and a second end; and
a second side trim piece configured to extend between the second end of the upper trim piece and the second end of the lower trim piece, and having a first end and a second end, wherein the second side trim piece is configured to be arranged at least approximately parallel to the first side trim piece;
wherein at least one of the first and second side trim pieces is configured to be coupled to at least one of the upper trim piece and the lower trim piece via at least one clasp; and
wherein the upper trim piece, the lower trim piece, the first side trim piece, and the second side trim piece form a trim assembly.

2. The trim kit of claim 1, the at least one clasp comprising a first clasp, wherein the first end of the first side trim piece comprises a first clasp portion, and the first end of the upper trim piece comprises a second clasp portion that is configured to couple with the first clasp portion to form a first clasp.

3. The trim kit of claim 2, wherein the second end of the first side trim piece comprises a third clasp portion, and the first end of the lower trim piece comprises a fourth clasp portion that is configured to couple with the third clasp portion to form a second clasp.

4. The trim kit of claim 3, wherein the first end of the second side trim piece comprises a fifth clasp portion, and the second end of the upper trim piece comprises a sixth clasp portion that is configured to couple with the fifth clasp portion to form a third clasp.

5. The trim kit of claim 4, wherein the second end of the second side trim piece comprises a seventh clasp portion, and the second end of the lower trim piece comprises an eighth clasp portion that is configured to couple with the seventh clasp portion to form a fourth clasp.

6. The trim kit of claim 1, wherein the microwave comprises a microwave configured to be installed in at least one of a recreational vehicle (RV), a camper, and a boat.

7. The trim kit of claim 2, the first clasp portion comprising an insertion member, the second clasp portion comprising a receiving member, and wherein the insertion member is configured to be inserted into the receiving member.

8. The trim kit of claim 1, wherein the first side trim piece includes a first mounting tab configured to engage a first mounting bracket extending from a first side of the microwave, and wherein the second side trim piece includes a second mounting tab configured to engage a second mounting bracket extending from the second side of the microwave.

9. The trim kit of claim 8, wherein the trim assembly can be mounted to the microwave without the use of independent fasteners.

10. A method, comprising:
assembling a trim assembly using a trim kit, wherein assembling the trim assembly comprises:
coupling a first end of a first side trim piece to a first end of an upper trim piece;
coupling a second end of the first side trim piece to a first end of a lower trim piece;
coupling a first end of a second side trim piece to a second end of the upper trim piece; and
coupling a second end of the second trim piece to a second end of the lower trim piece; and
coupling, without using independent fasteners, the trim assembly to the microwave.

11. The method of claim 10, wherein assembling the trim assembly is performed without using independent fasteners.

12. The method of claim 10, further comprising installing the microwave into a microwave cabinet prior to the step of coupling the trim assembly to the microwave.

13. The method of claim 10, wherein the first side trim piece is coupled to the upper trim piece using a first clasp and wherein the first side trim piece is coupled to the lower trim piece using a second clasp, wherein the first end of the first side trim piece comprises a first clasp portion, and the first end of the upper trim piece comprises a second clasp portion that is configured to couple with the first clasp portion to form the first clasp.

14. The method of claim 13, the first clasp portion comprising an insertion member, the second clasp portion comprising a receiving member, and wherein coupling the first side of the first side trim piece to the first side of the upper trim piece comprises inserting the insertion member into the receiving member.

15. The method of claim 10, the first side trim piece comprising a first mounting tab configured to engage a first mounting bracket extending from a first side of the microwave, the second side trim piece comprising a second mounting tab configured to engage a second mounting bracket extending from the second side of the microwave, wherein coupling the trim assembly to the microwave comprises pushing the trim assembly onto the front of the microwave so that the first and second mounting tabs engage the first and second mounting brackets, respectively.

16. A trim assembly for a microwave, wherein the microwave comprises a microwave configured to be installed in at least one of a recreational vehicle (RV), a camper, and a boat, the trim assembly comprising:
an upper trim piece having a first end and a second end;
a lower trim piece configured to be arranged at least approximately parallel to the upper trim piece, the lower trim piece having a first end and a second end;
a first side trim piece extending between the first end of the upper trim piece and the first end of the lower trim piece, and having a first end and a second end; and
a second side trim piece extending between the second end of the upper trim piece and the second end of the lower trim piece, and having a first end and a second end, wherein the second side trim piece is arranged at least approximately parallel to the first side trim piece;
wherein the first side trim piece includes a first mounting tab configured to engage a first mounting bracket extending from a first side of the microwave, and wherein the second side trim piece includes a second mounting tab configured to engage a second mounting bracket extending from the second side of the microwave; and
wherein the trim assembly is configured to be mounted to the microwave without the use of independent fasteners.

17. The trim assembly of claim 16, wherein at least one of the first and second side trim pieces is configured to be coupled to at least one of the upper trim piece and the lower trim piece via at least one clasp.

18. The trim assembly of claim 17, the at least one clasp comprising a first clasp, wherein the first end of the first side trim piece comprises a first clasp portion, and the first end of the upper trim piece comprises a second clasp portion that is configured to couple with the first clasp portion to form a first clasp.

19. The trim assembly of claim 18, the first clasp portion comprising an insertion member, the second clasp portion comprising a receiving member, and wherein the insertion member is configured to be inserted into the receiving member.

20. The trim assembly of claim 16, the receiving member comprising an inner wall, at least a portion of the inner wall defining at least a portion of an aperture, and a first guide feature disposed on the inner wall, wherein the insertion member includes a second guide feature configured to engage the first guide feature when the insertion member is inserted into the receiving member.
